(19) United States
(12) Patent Application Publication
(10) Pub. No.: US 2009/0241174 A1
(43) Pub. Date: Sep. 24, 2009

(54) Handling Human Detection for Devices Connected Over a Network

(76) Inventors: Guru Rajan, Alpharetta, GA (US); Ajay Varghese, Alpharetta, GA (US); Vishal Gautam, Alpharetta, GA (US); Yuancai Ye, Alpharetta, GA (US)

Correspondence Address: Brian Anderson, 5250 Meadowcreek Drive, Dunwoody, GA, 30338, US

(21) Appl. No.: 12/389,263

(22) Filed: Feb. 19, 2009

Related U.S. Application Data
(60) Provisional application No. 61/029,701, filed on Feb. 19, 2008.

(51) Int. Cl. G06F 17/30; G06F 3/033

(52) U.S. Cl. 726/5; 715/863

(57) ABSTRACT

A system and method for determining whether a user of a computer is a human, comprising: generating dynamic request code asking the user for information; sending the dynamic request code to the computer; receiving validation code as an answer to the dynamic request code; and determining whether or not the validation code was generated by a human.

### CROSS REFERENCE TO RELATED APPLICATION

This application claims the benefit under 35 U.S.C. § 119(e) of U.S. provisional patent application no. 61/029,701, entitled “Method and System for Determining if a Human is Using a Computer,” filed Feb. 19, 2008, which is incorporated herein in its entirety by reference.

### BACKGROUND OF THE PRESENT INVENTION

The Internet was created for humans to interact and this interaction enabled a lot more applications with social and enterprise aspects to reach to their constituent audience. However, back actors also used the same channels to interact and impersonate human interaction to sites that were intended for only for the general audiences. The initial stages of the Internet development did not predict this trouble of impersonators. Automated agents began to use this avenue to generate revenue by pretending to be human actor or gain access to valuable data. To solve this problem, the present invention was developed by tracking the real interaction of human behavior on a given site or form. The present real-time validation and plug-and-play module enablement is versatile and provides a greater degree of protection and accuracy than is currently available for on-line valuable transactions.

### BRIEF DESCRIPTION OF THE FIGURES

FIG. 1 is a system diagram illustrating a system for determining if a human user is using a client computer, according to one embodiment.

FIGS. 2-4 are flowcharts illustrating various methods for determining if a human user is using a client computer, according to several embodiments.

FIGS. 5-7 illustrate various examples of information requested by the dynamic request code, according to several embodiments.

FIG. 8 illustrates a screen shot where the humans are represented by pictures of a woman 805, and the non-human user is highlighted 810.

### DESCRIPTION OF EMBODIMENTS OF THE INVENTION

Due to the nature of security, there is bound to have threat issues surrounding any implementation; however keeping this possibility to a minimum is always the challenge. The present approach assumes that the hacker is going to somehow reverse engineer any java script given to the browser. Yet, even when the system is hacked, they are unable to proceed further.

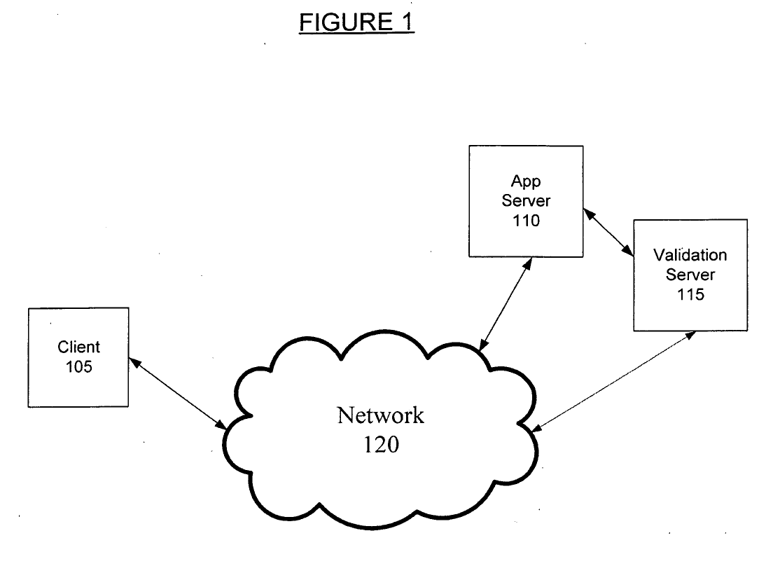

FIG. 1 is a system diagram illustrating a system for determining if a human user is using a client computer 105, according to one embodiment. The client computer 105 is any computer device (e.g., a personal computer, mobile and/or handheld device) which attempts to communicate with any another computer device through a network 120 (e.g., the Internet, an intranet, wide area networks (WANs)). In one embodiment, the client computer 105 can communicate with an application server 110. For example, Customer A can utilize the client computer 105 to communicate with Company B's web site at an application server 110. As another example, Customer A can utilize the client computer 105 to send an email to Company B's application server 110. Validation server 115 can be a server that communicates with the application server 110 in order to determine if information sent from the client 105 to the application server 110 is generated by a human user. Validation server 115 can be separate from application server 110 or the function of both can be integrated into a single computer. The validation server 115 can be run by an outside entity (e.g., computer security company) or run by the owner of the application server 110. It is relevant to determine if the information is generated by a human user because many automated agents using the Internet can do various kinds of damage using a large number of client computers 105. Many client computers 105 are infected with agents without their owners' knowledge. The agents can generate email messages, click on web advertisements, create bogus web sites and web links, initiate improper server requests that interfere with the proper functioning of an entity's application server 110, retrieve sensitive data, create bogus accounts, buy and/or sell products or services in an improper manner, etc. For example, spam email messages can clog communication lines, mail servers, and email boxes. Being able to allow only human generated email messages could help cut down on such spam email. In addition, agent-generated fraudulent clicks on web advertisements compromise the ability of search engines to provide accurate statistics when charging advertisers under pay-per-click business models. Agents can also be used maliciously to create and host large numbers of web pages and link patterns that fool search engines into boosting the ranking of pages erroneously. If search engine crawlers and ranking systems are able to allow only human-generated pages and links, they could more correctly rank page relevance and mitigate link-spam. In addition, agents can be employed to leak sensitive data stored on client. Such agents can package sensitive data into innocuous-seeming email messages that are then sent to email “dead drops” for later retrieval. If organizations are able to stop agent-created messages from leaving their networks, they can reduce the risk that sensitive data leaks surreptitiously. Agents can also be used to buy or sell products or services in an improper manner, such as buying all available tickets to a concert in 10 minutes. By only allowing humans to buy or sell products and/or services, abuse can be avoided. It is also helpful to check to see if a human is entering in information that is captured and utilized by a system for registration purposes in order to make sure the system isn't registering a non-human agent.

For all of the above reasons, as well as many others, the validation server 115 determines whether or not a human user is using the client 105 by determining if a certain physical action or actions are taken. If the certain physical action or actions are taken, a validation code (also referred to as an artifact) is generated. In one embodiment, referred to as an intrusive validation driver solution (because special software needs to be installed), a badge can also be created for the validation code. Badges are numbers that are difficult to forge. The validation server 115 can use a computerized method to check if a validation code is generated by a user and/or can also check for valid badges. Unlike automated software agents, for humans to produce validation codes (artifacts), they can press buttons and move computer peripheral devices such as keyboards, mice, and styli. At a pre-determined point in the creation of the validation code (artifact), a specific physical act or series of physical acts are performed. Such acts are dynamically determined and requested, as explained below, in order to avoid a non-human agent pretending to be a human by guessing the required acts and responding appropriately. In one embodiment, these physical acts cause the creation of an un-forgeable badge associated with that particular validation code (artifact).

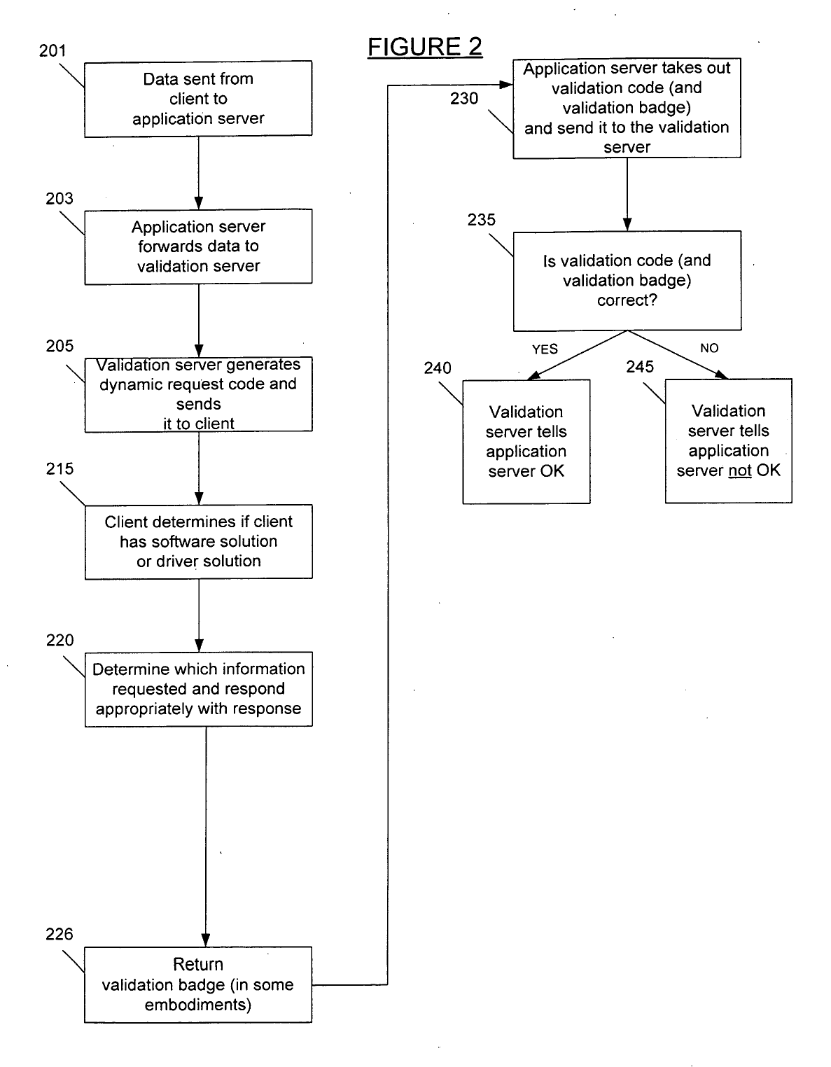

FIG. 2 is a flowchart describing a method for determining if a human user is using a client computer 105, according to one embodiment. In 201, data is sent from the client 105 through the Internet 120 to the application server 110. For example, a customer (client 105) can try to access a company's website (application server 110). In 203, this data can be forwarded by the application server to the validation server 115. As mentioned before, the validation server 115 can be run by an outside entity (e.g., computer security company) or run by the owner of the application server 110. In 205, the validation server 115 generates a dynamic request code which is sent to the client 105. In the example above, this dynamic request code can be sent with an application page request to the client 105. The dynamic request code can ask the client 105 to return specific information which indicates that a human user is currently using the client 105. The validation server 115 can include a dynamic request code generation function, or the dynamic request code generation function can be resident in one or more clusters of computers to handle large volume requests. Because the dynamic request code can change, the information that is requested from the client 105 can be constantly changing. The dynamic request code which requests different types of information prevents non-human agents from trying to guess what type of information should be returned to the validation server 115 as a validation code (artifacts) in response to the dynamic request code. For example, the dynamic request code for a client 105 can be included in a particular transparent pane display. The dynamic request code for another client 105 (or the same client 105 at another point in time) can be related to mouse movement, browser activity, or steal-click activity. These types of user activity are described in more detail below.

The dynamic code morpher picks a set of random strategies based on given know set. For example, the total number of strategies in the pool is around 30 and there might be 8-10 key strategies that needs to be picked from and rest or optional. This is used to handle the effectiveness based on the browser. For every new connection that is coming in for a request of a particular page on the application site, 5-6 strategies are created and pooled, then as one single java script delivered to the browser. There certain minimum strategies such as ipvalidator and browser validators which are typically always included. Exemplary strategies include the following:

IP Validator:

Generally speaking a client machine is going to ensure that all communication are with the specified client. This in the industry lingo is called as session management. Hackers are not wanting the servers to understand where they are coming from and hence will use more deceptive tactics such as caching proxy or Tor Networks to ensure the real client is hidden from the server. This will not reveal who the true client is but appear to the server as another client. To avoid this situation, HPMx generates an randomized time variable and uses the IP address it received the request from and creates a token with the combination and encrypts it and send it back to the requester as a token. The browser when submitting the content back to the application server will also indicate which ip address it is coming from. The app server will then use the new ip address and decode the time variable and encrypt this to see if the passed token and currently generated token match. If this does not match, a failure score is generated for this strategy. This is a mandatory test.

Browser Validatior:

HPMx technology currently is implemented only for HTTP/HTTPS based protocol stack applications. In future we will port this technology to handle custom protocols suitable for games and other application. In the case of the browser there are a variety of browsers available in the market space and for all practical purpose we are going to stop at the 95% of all available browsers. The browser will generally send a request to a page and once rendered will transmit the collected data back to the server either using a GET/POST mechanism. On the server side, all one can see is what the browser name is. To ensure that this is indeed the named browser, HPMx will send some code that can be executed only in that specific browser. For example if you involve a all for ActiveScript on a firefox browser it will not work as this is intended for only Internet Explorer. Similarly there are various options to ensure the browser name that we got is infact the named browser. This test is a mandatory test.

Mouse Movement validator:

HPMX collects all the mouse movement from the browser to a plot and see if this constitutes a normal human behavior. Mouse movement are trigger as events based on majority of the operating systems. They can have independent movement even if the OS is busy doing other work. Hence there is a possibility of missing real movements from the device. Also the movement is based on relative location and idle time. In other words if the current mouse position is around 200,800 (due to two dimensional space of the browser), and the next delta is +20, −40 meaning the new position is 220, 760. Also, there is something called the acceleration. If the directional movement of the mouse is such a speed based on the users actions, there accelerating factor can be increased. Say the user wants to go from lower left edge of the screen to the top right edge, then the accelerator will be applied. What It means is that same directional movement will be factored, eg moving from the left edge of the screen to the top right of the screen, generally will come as 10,1060:40−60×10. In this example the end point is 410, 460. This is a simple way of communicating. Tracking all the mouse movements on a given page, the validator will use a spacial map to detect whether the current movement is human behavior or not. The comparison is against all know data collection that is part of the hureistic database.

Event Validation:

This strategy will collect based event associated with this particular form it is interested in know which key or all of the browser which event occurred in what sequence. Once collected these are classified using a pre defined know database of event collection that constitute whether this is possible for a human or not. Event validation include some the following collection at the input device level, Keyboard event, such as keypressed (keydown and keyup), mouse movement, moving between defined data element etc. Generally the rate at which human type, in average for every x characters typed there is always an mistake where by the user will use the back stock (delete or other characters to change the data. In case of a bot it knows what it type all the type and will not have any of these special characters in the data elements. The event validation is looking for these key differentiations to determine the classification of the human vs automated agents. Eg below shows some the event validations.

keydown, keyup, some character, keydown, keyup, some character, keydown keydown, keyup some character, keyup, some character.

This is for sure a human being as the 3^{rd} typing they pressed two keys at the same time and the character do pop out at different interval. Similar to this is what this validation is accomplished to see if there are any key and significant difference on how humans and automated agent behave.

Event Sampling:

This strategy eliminates any of the duplicate submission over a period of time. The event validation is collecting all event samples from the system, which includes all keyboard and mouse event. The system part of the human present detection will update an realtime database keeping track of how many times for a given page the data is repeating during that time. Based on a straight forward database match, the events can be found to be duplicate. This is very key as automated agent will use as much as duplicate data that is possible as they are trying to do this quick etc. Once a certain amount of events are duplicate it can classify this as an automated submission.

Event Timing:

For every event there are certain CPU cycle that needs to be spend. The difference is for each of the keyboard events for example, if you need to type the letter “A” to appear in the form, then a minimum of 3 key events that are required, such as keydown, <character A>, keyup. The timing information between each of these event are pre calculated based on the rate at which a user can type, such as a fast typist and slow one. These ranges help in classifying whether this is normal or abnormal and a cumulative collection of event timing given can be mapped to a predetermined value of ranges for this (based on historical and logical derivation). This helps one to classify whether this range is good or bad.

Steal Click:

This is one of the key reactive measures for detecting a normal human behavior. If the user submits his data and the system can deliberately not do the action of submission. This will cause a normal human unconscious reaction of resubmitting the data, where as a bot/automated agent will look to see if any data has comeback from the submission. The time delta between the time the last submission and the current submission is also captured to see if this is between a predetermined timeline. If the range is between predetermined intervals, then it is a normal human reaction. Also after initial submission, human generally will use other associated actions within the forms, such as moving the mouse randomly to see if the system is frozen or not.

Transparent Display Pane:

Discussed in further detail below.

Add Character:

Another key reactive strategy is to force an extra character that the user typed. Humans during the typing operation will see that there is a mistake and will correct this immediately by using the <backspace> or clicking the mouse of the relative location where the extra character was present. This will not happen when a bot is typing. When the data is submitted for validation, the validation process know on which random location was the extra character inserted (tracking all the event data using the event validation) and see if the user has done any corrections to this. If the inserted character is still present then it is classified as non human being.

Also it assigns randomized names to the value that needs to return from the browser. For example standard web forms will have the comeback in name, value pairs such as username, value, userpassword, password and so on. In this case the bot (automated agents) really knows that the username column needs to be populated with the hijacked or know username, and userpassword with the correct password. Programmatically this will allow the bot to login with no trouble. In our case the name will be a random assigned string like x31sxas, and password name will be x321asdaq. If the bot needs to login it needs to now read the page and find x31sxas means username and x321asdaq means password, before it can submit the hijacked user name. This is a very prime case of obsification that protects the pages.

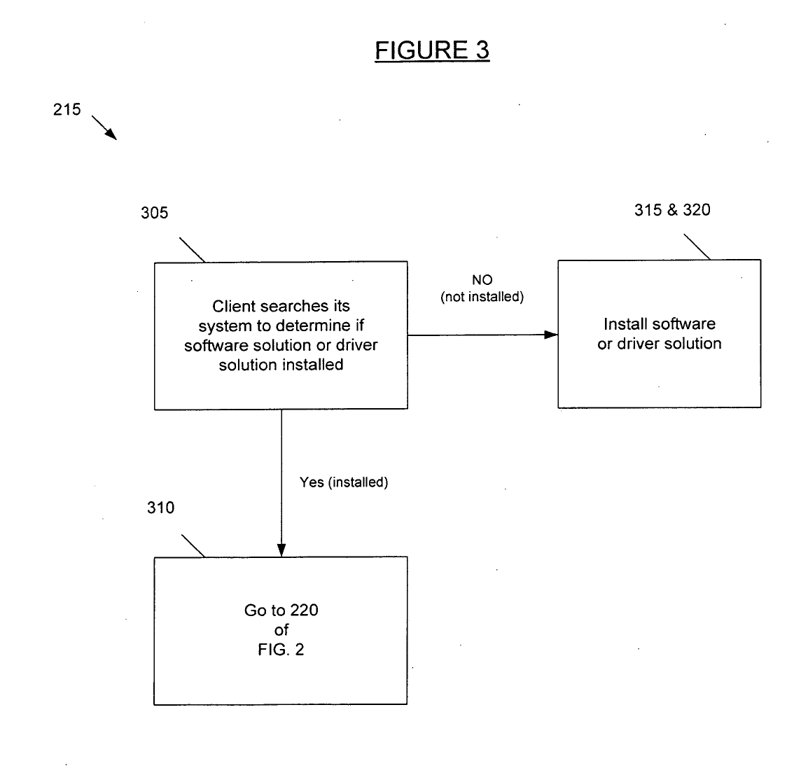

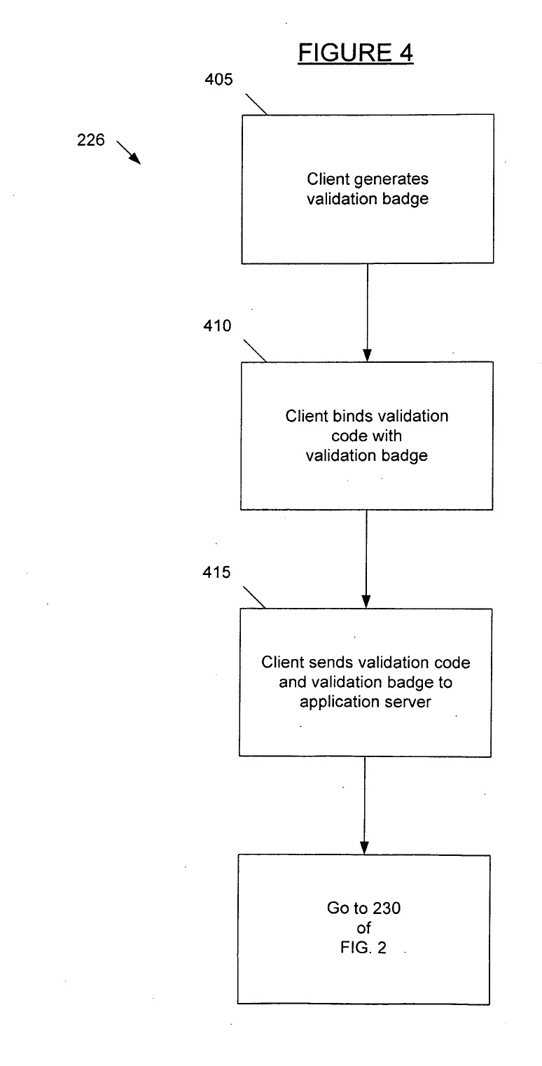

In 215, the client 105 determines if the client 105 has a validation software solution (a non-intrusive solution) or a validation driver solution (an intrusive solution); and if not, installs the appropriate solution. This process is detailed in FIG. 3. In 220, once it has been determined that the appropriate solution is installed, the generated dynamic request code works with the validation software solution or the validation driver solution at the client 105 to make a request of the person operating client 105. If the user responds appropriately, client 105 sends a validation code to the application server 110. In 226, in some embodiments, a validation badge (when used) can also be sent at the same time as the validation code (The process of generating the validation badge is set forth below in FIG. 4.) In 230, the application server 10 extracts the validation code and sends it (in some embodiments with the validation badge) to the validation server 115. If there is not any validation code, the process returns to 201 and the original data (e.g., in the example, the request for the company's web page) must be resent from the client 105, and the process 201-230 must be repeated. If there is a validation code, the process moves to 235, where it is determined if the validation code is correct (i.e., which means a human user is currently using the client 105). At this point, in some embodiments, it can also be determined if the validation badge is also correct. If yes, the validation code and/or validation badge are correct, in 240, and the validation server 115 communicates this information to Company B (using application server 110), which accepts the request and proceeds with business as usual because the company now knows it is interacting with a human user. If no, the validation code and/or the validation badge are not correct, and in 245, the validation server 115 communicates this information to the company (using application server 110), which then determines whether or not it wants to proceed using internal company guidelines. Thus, for example, the company can have rules set up that require extra monitoring (e.g., extra information asked of client 105, such as a phone number) or reject connection to client 105 from that period onwards.

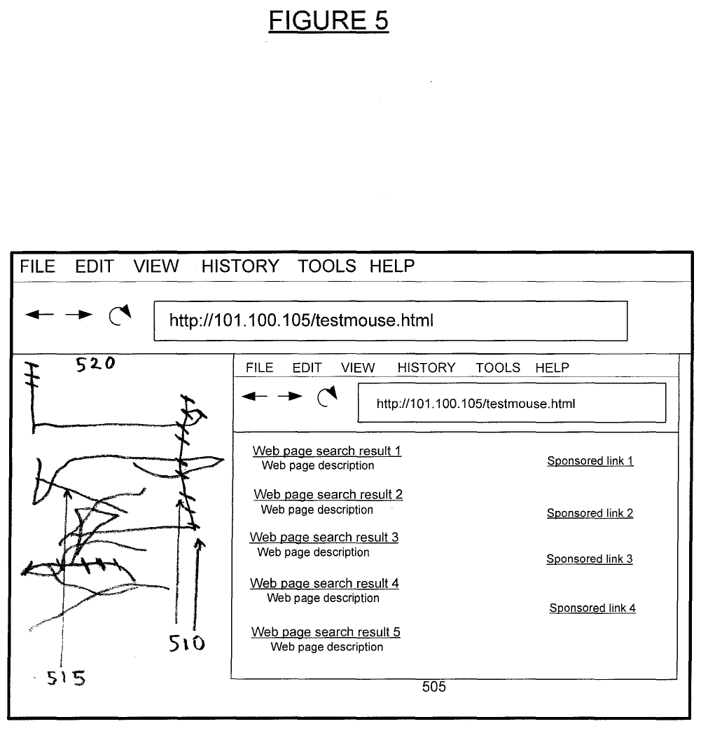

FIGS. 5-7 illustrate various examples of the dynamic request code, according to several embodiments. Note that each type of information in the dynamic request code can be requested of the user of client 105, or a combination of types of information can be requested of the user of the client 105 (e.g., mouse click information and browser information). The following explanations set forth examples of separate uses of each type of information. However, those of ordinary skill in the art will see that combining two types of information can simply be done by putting requests for both types of information in the dynamic request code.

If the dynamic request code requests information asked for in a transparent pane display, a human can be asked to respond appropriately. A transparent pane display is similar to the concept of a security mirror at a police station, where one side is a see-through glass display, and the other side is a non-see-through mirror. For example, if a human is looking at a web site in order to buy a product, the transparent pane can be on top of and identical to the transaction site. The human will not be able to differentiate whether they are entering information (e.g., credit card info) on the actual web site or the transparent pane. This helps in identifying whether the information being entered is from a human user or a computerized agent, because the human will enter in the information requested in the transparent pane. In contrast, a computer agent will only “see” information that represents the web site under the transparent pane, and enter in whatever information is requested on the web site. Thus, the dynamic request code can request information which is requested in a transparent pane. If the client 105 returns the correct answer as validation code, the validation server 115 knows the user of the client 105 is a human.

As another example, the dynamic request code can request mouse movement information. Thus, the dynamic code request can ask for all mouse movement within a certain time period and return that mouse movement information to the validation server 115 as the authorization code in response to the dynamic code request. Such mouse movement information can help indicate whether or not a user of the client 105 is human, because only humans generally use a mouse by dragging it from one part of a web page to another part of a web page. To illustrate this concept, FIG. 5 displays a graph of various mouse movements in box 520, which correspond with a user navigating various parts of a web page, which URLs are described in 505. When a human navigates a web page, a mouse is almost always dragged around. Points 510 correspond to the various parts of the web page, and line 515 is the path the mouse follows to click on these various parts of the web page. In contrast, when a non-human agent navigates a web page, the mouse movement jumps from one part of the web page to another part of the web page, because a machine agent will click directly on the various parts of the web page.

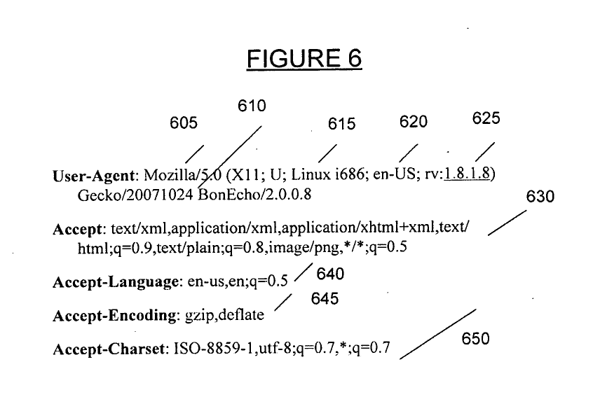

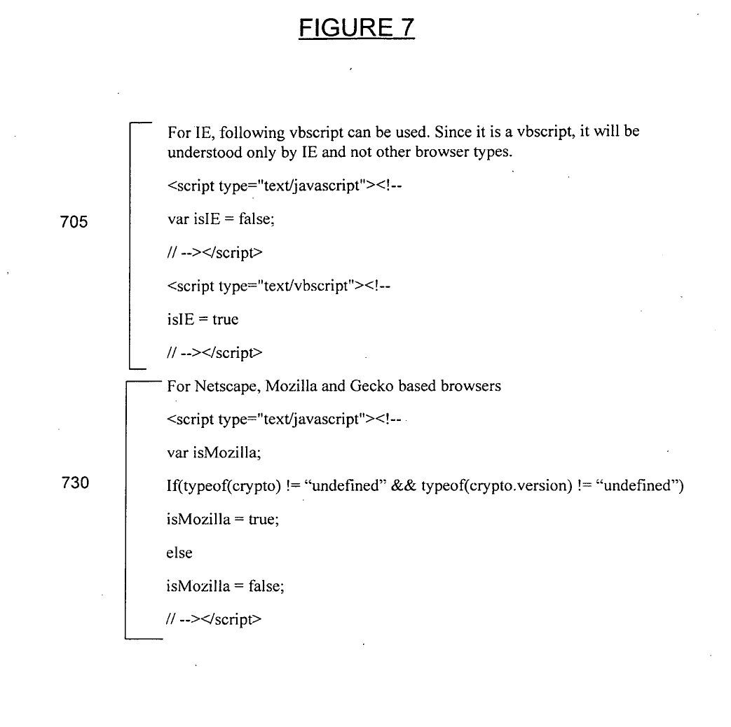

As an additional example, the dynamic request code can request information related to the browser activity of the client 105. Browser information can be important because most human users will have one of several standard browsers. However, many computerized agents will have their own proprietary browsers, but they may have code that indicates they have one of the standard browsers in order to appear to be normal clients. The validation server 115 can determine what type of browser the client 105 claims to be using by information in the original contact the client 105 made with the browser. For example, FIG. 6 illustrates browser information for a client 105: Mozilla 5.0 (605) is the browser's official name; Linux i686 (615) is the computer running the browser (i.e., the client 105); en-US (620) indicates that it is a US English keyboard the client 105 is using; 20071024 (610) indicates the date. The accept line of code (630) indicates the various capabilities the client 105 claims to have. The language 640 indicates the client 105 uses US English. The encoding (645) indicates what type of compression the client 105 can employ. The character set 650 indicates what character set the client 105 uses. Once the validation server 115 has this information, it can then generate the dynamic request code requesting information proprietary to that particular browser. This will enable the validation server 115 to check to see if the client 105 actually has the browser it claims to have. FIG. 7 illustrates how the dynamic request code can request various information from various browsers. The code in 705 can be used for an Internet Explorer (IE) browser. IE has a specific type of tool called vbscript, which can be used to invoke another application automatically (e.g., an audio player). The dynamic request code can send code 705 requesting if the browser has vbscript. If vbscript is not on the browser, code indicating “false” will be returned as validation code. In this case, the validation server will be able to determine that the browser is not IE, if claimed. If vbscript is on the browser, code indicating “true” will be returned as validation code. In this case, the validation server 115 will be able to determine that the browser is IE, if claimed.

The code in 730 can be used for a Netscape, Mozilla or Gecko browser. Each of these browsers is not able to decrypt. The dynamic request code can send code 730 requesting the validation code to indicate if the browser has a decryption capability. If this capability is not on the browser, the validation server will be able to determine that the browser is likely Netscape, Mozilla or Gecko, if claimed. If the decryption capability is on the browser, the validation server will be able to determine that the browser is not Netscape, Mozilla or Gecko, if claimed.

Another example of information that can be requested by the dynamic request code is steal click information. The use of steal click information is based on the premise that humans often click a link in a given interface several times (e.g., because they think their computer is too slow). Computerized agents will not do this. Taking advantage of this fact, the validation software on the client 105 can be programmed to eat one of the clicks, causing the human user to click the same action again. The dynamic request code can request a time difference between the first click and the second click. This time difference information will be sent to the validation server 115 as the validation code. If there is not a second click, or the second click comes after too long of a pause, the time difference will not fall within the required time period, and the validation code will not be correct.

FIG. 3 illustrates a flow chart setting forth the details of determining if the client 105 has a validation software solution (e.g., in some embodiments, a non-intrusive solution which is already included in or compatible with the client's current browser) or a validation driver solution (an intrusive solution that is installed on client 105), and if not, installing the appropriate solution, according to one embodiment. In 305, the client 105 searches its system to determine if the validation software solution or the validation driver solution is on the client's system. (Note that, in some embodiments, the client's current browser is able to execute the validation software solution and that additional software may not need to be installed.) If not, in 310, the client is asked if it wishes to install the validation driver solution (intrusive). (Note that in some embodiments, the validation software solution could be installed without receiving authorization from the client. Also note that in some embodiments, the application server 110 can determine whether or not the client 105 must install the validation software solution and/or the validation driver solution.) In 315, if the client chooses to install the validation software solution, this software is installed. Those of ordinary experience in the art will understand how this is done. In 320, if the client chooses to install the validation driver solution, a device driver for human interactive devices can be installed. The installer can use any standard industry mechanism available based on the specific operating system the client 105 is running. (e.g., Install Shield, SetUp.exe, Microsoft Installer (MSI)).

FIG. 4 illustrates a method of generating a validation badge, according to one embodiment. As illustrated in FIG. 2, in some embodiments, the application server 110 can require a validation badge in addition to the correct validation code (described above). In these cases, the client 105 must send the validation code and the validation badge to the validation server 115. In 405, the client 105 generates the validation badge (i.e., token) using the installed validation driver application. The client 105 generates the validation badge using particular information that the validation server 115 has for each particular client 105. Thus, for example, the validation server 115 can store for each client 105 an ID (e.g., the client's IP address), and hⁿ(s), where h is a cryptographically secure hash function (e.g., MD5), n is a number/limit (e.g., 10,000), and s is a random secret for the client 105. The client 105 can store hⁿ⁻¹(s), . . . h(s) as a sequence of validation badges. Note that the validation badges can be generated in a multitude of ways, and this is merely one example. When the dynamic request code is answered using the appropriate validation code (e.g., clicks or key presses by a human user), and the client 105 is sending a validation badge, the client 105 is induced to release the next validation badge (i.e., token) t in sequence. Thus, if t=hⁿ⁻¹(s) for the validation badge to go with the first validation code, the next validation code gets a different validation badge: t=hⁿ⁻²(s). In 410, the client 105 binds the validation badge with the validation code. There are multiple ways to do this. For example, if the validation code is an email message, the validation badge can be a special field (or variable) in the email header that stores the token. As another example, if the validation code is a URL, the validation badge can be a variable in the URL that stores the token. In 415, the client 105 sends the validation badge and the validation code to the application server 110. The application server 110 then sends the validation badge and the validation code to the validation server 115. The validation server 115 looks up the client 105's ID, and compares the validation badge with the stored value for that client 105. If they match, the client's new stored value is t, and the validation server 115 communicates to the application server 110 that t is valid. Otherwise, the validation server 115 communicates to the application server 110 that t is invalid. Note that this scheme can be extended to check if a validation badge is used (improperly) more than once. Thus, in one embodiment, the validation server 115 always keeps the hⁿ(s) value. When it gets a validation badge t′ from the client 105 and sees that it is not a valid validation badge (i.e., h(t′) is not the same as the stored h(g) value), it computes h^{k}(t′), for k=2 to n, and it if sees h^{k}(t′)=hⁿ(s) it has detected a duplicate validation badge..

In one embodiment, another scheme can be used to generate the validation badge. The client 105 can store s and n, and computer hⁿ⁻¹(s), . . . , h(s) for each human generated artifact (validation code). Note that many other types of schemes known to those of ordinary skill in the art can be used to generate the validation badge.

In one embodiment, all storage/release/computation of validation badges is on the client 105 and is tamper resistant. That is, mechanisms known to those of ordinary skill in the art may be employed on the client 105 to ensure that an eavesdropper or malicious agent on the computer cannot effectively intercept the generation of the validation badge and use it for another purpose. This can be done with protected software channels or through encryption. In one embodiment, the validation badge mechanism can be implemented in firmware so that it cannot be tampered with. In another embodiment, a virtual machine based scheme (with appropriate hardware support) can be utilized.

In one embodiment, the validation server 115 can be a distributed service. Thus, parts of the validation server 115 can sit in different locations. In one embodiment, the validation server 115 can release validation badges in a distributed way to the different locations and over time so that distant, disparate parties may independently verify the verification badge.

In one embodiment, set up of the validation badge can be redone whenever all n versions of the validation badge are generated and used up by the client 105 or when there is a need to refresh the validation badge information (e.g., when a client 105 is re-installed). There are multiple ways to do this. In one embodiment, the client 105 and the validation server 115 can establish the shared secret s using a number of standard cryptographic protocols (e.g., Diffie-Hellman with signing).

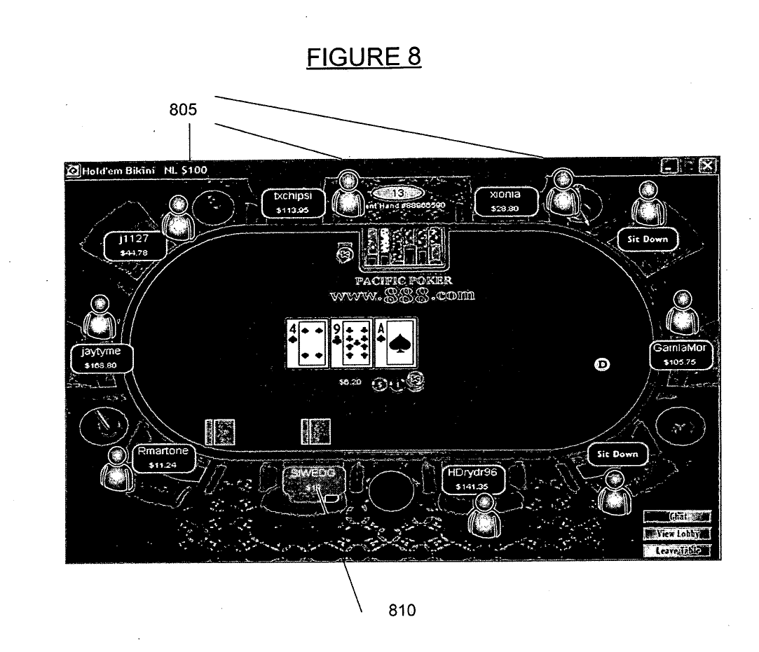

In one embodiment, icons can be used to show whether or not certain users of clients 105 are human. FIG. 8 illustrates a screen shot where the humans are represented by pictures of a woman 805, and the non-human user is highlighted 810.

In the above examples of the strategies, the user or the computer he uses is collecting the said data on the browser. The transport of this data to the validation server can be accomplished in multiple ways. For example, a hidden form field can contain this data, or the browser can post this directly to the pramana server farms, or it can send it through the application layer using post or available mechanism suitable. Once the data is come back the following flow of logic will happen:
1) The system will check to see If the ip address it sent the code matches the ip address from where the data came from.
2) Checks to see if the tag (token) is matching for this session it gave along with the dynamic code.
3) To make sure the client cannot hack the results being collected, each collection mechanism will have a unique name, value combination which was given to it during the code generation. This name tag is check to see if the value for it matches the requested strategy.
4) each of the strategies are then validated to make sure they either are valid or not valid.
5) Include any Hueristic database score for the ip and event data into the scoring algorithm.
6) Based on the applications threshold, each of these strategies for the given customer will have confidence multiplier, which is then applied to the respective score. All evaluation of the strategies score are from the range of configured for that customer. If the customer score are empty then the system default ranges are used. This gives ultimate flexibility in tuning for a given environment.
7) Running through a algorithm to ensure the aggregation of these scores into a final human index to say it human or not human.
   a. Simply formulae is said below but can be continued to tune to have better effectiveness
   Score =(Strategry_score)/100*(confidence)/100
   where the Strategy_score comes from the strategy valiadation, and confidence is based on the how the effectiveness of this strategy relative to others.
8) The aggregation of the score above , will all in one of the available buckets to be classified as human, non human, neutral.
9) The connection and all event related data that is collected for this session will be updating the heuristic database for further classification and matching.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A computerized method of determining whether a user of a computer is a human, comprising:
generating dynamic request code asking the user for information;
sending the dynamic request code to the computer;
receiving validation code as an answer to the dynamic request code; and
determining whether or not the validation code was generated by a human.

2. The method of claim 1, wherein a validation badge is sent with the validation code.

3. The method of claim 1, wherein the information requested by the dynamic request code relates to a transparent pane display.

4. The method of claim 1, wherein the information requested by the dynamic request code relates to mouse movement.

5. The method of claim 1, wherein the information requested by the dynamic request code relates to browser activity.

6. The method of claim 1, wherein the information requested by the dynamic request code relates to steal click information.

7. A system for determining whether a user of a computer is a human, comprising a computer with an application for:
generating dynamic request code asking the user for information;
sending the dynamic request code to the computer;
receiving validation code as an answer to the dynamic request code; and
determining whether or not the validation code was generated by a human.

8. The system of claim 7, wherein a validation badge is sent with the validation code.

9. The system of claim 7, wherein the information requested by the dynamic request code relates to a transparent pane display.

10. The system of claim 7, wherein the information requested by the dynamic request code relates to mouse movement.

11. The system of claim 7, wherein the information requested by the dynamic request code relates to browser activity.

12. The system of claim 7, wherein the information requested by the dynamic request code relates to steal click information.
